(19) United States
(12) Patent Application Publication
(10) Pub. No.: US 2021/0397717 A1
(43) Pub. Date: Dec. 23, 2021

(54) SOFTWARE INFORMATION ANALYSIS

(71) Applicant: INTERNATIONAL BUSINESS MACHINES CORPORATION, ARMONK, NY (US)

(72) Inventors: Larisa Shwartz, Greenwich, CT (US); Murilo Goncalves de Aguiar, Sao Paulo (BR); Eric Joel Olson, Burnsville, MN (US); Milton H. Hernandez, Tenafly, NJ (US)

(21) Appl. No.: 16/907,241

(22) Filed: Jun. 20, 2020

(51) Int. Cl. G06F 21/57; G06F 11/30; G06F 8/77; G06K 9/62

(52) U.S. Cl. CPC G06F 21/577; G06F 11/302; G06F 2221/033; G06K 9/6284; G06F 8/77

(57) ABSTRACT

A software information analysis system that assesses the operational risks of using a particular set of software is provided. The system identifies one or more software entities used by one or more applications operating in an environment. The system collects information relevant to the identified one or more software entities. The system extracts opinions regarding the identified one or more software entities in the collected information. The system calculates an operational risk metric for the environment based on sentiments expressed in the extracted opinions. Each extracted opinion is weighted based on a personal identity associated with the extracted opinion.

### BACKGROUND

### Technical Field

The present disclosure generally relates to analyzing software information in order to assess possible operational risks or other issues associated with using a particular set of software.

### Description of the Related Arts

Open-Source Software (OSS) is a type of computer software in which source code is released under a license in which the copyright holder grants users the rights to study, change, and distribute the software to anyone and for any purpose. Open-source software may be developed in a collaborative public manner.

### SUMMARY

Some embodiments of the disclosure provide a software information analysis system that assess the operational risks of using a particular set of software. For example, in some embodiment, the software information analysis system identifies one or more software entities. The system collects information relevant to the identified one or more software entities. The system extracts opinions regarding the identified one or more software entities in the collected information. The system then calculates an operational risk metric based on sentiments expressed in the extracted opinions. Each extracted opinion is weighted based on a personal identity associated with the extracted opinion.

The preceding Summary is intended to serve as a brief introduction to some embodiments of the disclosure. It is not meant to be an introduction or overview of all inventive subject matter disclosed in this document. The Detailed Description that follows and the Drawings that are referred to in the Detailed Description will further describe the embodiments described in the Summary as well as other embodiments. Accordingly, to understand all the embodiments described by this document, a Summary, Detailed Description and the Drawings are provided. Moreover, the claimed subject matter is not to be limited by the illustrative details in the Summary, Detailed Description, and the Drawings, but rather is to be defined by the appended claims, because the claimed subject matter can be embodied in other specific forms without departing from the spirit of the subject matter.

### BRIEF DESCRIPTION OF THE DRAWINGS

The drawings are of illustrative embodiments. They do not illustrate all embodiments. Other embodiments may be used in addition or instead. Details that may be apparent or unnecessary may be omitted to save space or for more effective illustration. Some embodiments may be practiced with additional components or steps and/or without all of the components or steps that are illustrated. When the same numeral appears in different drawings, it refers to the same or like components or steps.

FIG. 1 illustrates a software information analysis system that assess the operations risks of using a particular set of software in an Information Technology (IT) environment.

FIG. 2 illustrates a block diagram of an example implementation of the software information analysis system.

FIG. 3 conceptually illustrates a process for assessing operational risks in using a particular set of software, consistent with an exemplary embodiment.

FIG. 4 shows a block diagram of the components of a data processing system in accordance with an illustrative embodiment.

FIG. 5 illustrates an example cloud-computing environment.

FIG. 6 illustrates a set of functional abstraction layers provided by a cloud-computing environment, consistent with an exemplary embodiment.

### DETAILED DESCRIPTION

In the following detailed description, numerous specific details are set forth by way of examples in order to provide a thorough understanding of the relevant teachings. However, it should be apparent that the present teachings may be practiced without such details. In other instances, well-known methods, procedures, components, and/or circuitry have been described at a relatively high-level, without detail, in order to avoid unnecessarily obscuring aspects of the present teachings.

Some embodiments of the disclosure provide a software information analysis system that collects information regarding a particular set of software, and analyzes the collected information to identifies issues associated with using the set of software. In some embodiments, the system analyzes the collected information in order to assess the operation risks of using the software. For example, in some embodiments, the software information analysis system is used to assess the operational risks of using certain Open-Source Software (OSS).

A user of an OSS program can send bug reports to the distributor or a trusted repository, just as for a proprietary program. The user of the OSS program can also make changes to the OSS program itself. Since it is advantageous for the user to use the improvements made by others, the user has a strong incentive to submit the improvements made to the trusted repository for the OSS program. That way, the user's improvement can merge with others' improvements, enabling the user to use all available improvements instead of only his own. This can create an avalanche-like “virtuous cycle.” As the OSS program becomes more capable, more users are attracted to using the program, and some of the users will participate in making improvements to the program. As more improvements are made, more people can use the program and potentially participate as developers.

However, there may be operational risks associated with using OSS in software and/or services, since OSS programs may not be fully verified for functional and/or security purposes. Operational risks of using OSS can be difficult to ascertain, such as when an IT environment is using a third-party service that may be using OSS programs.

To facilitate the present discussion, an IT environment is described by way of example only and not by way of limitation. It will be understood that other environments are within the scope of the present disclosure. Some embodiments of the disclosure provide a software information analysis system that assess the possible operational risks of using a particular set of software (e.g., open-source software) that may be used, for example, in an IT environment. In some embodiments, the system identifies one or more software entities (e.g., open-source programs, source code fragments, libraries, services, etc.) used by one or more applications operating in the IT environment. The system collects information relevant to the identified one or more software entities. The system extracts opinions regarding the identified one or more software entities in the collected information. The system then calculates an operational risk metric for the IT environment based on sentiments expressed in the extracted opinions. Each extracted opinion is weighted based on a personal identity (of e.g., an open-source participant) associated with the extracted opinion. In other words, the system assists in identifying potential issues for using the software entities in part based on how opinions regarding the software entities are expressed and who expressed those opinions.

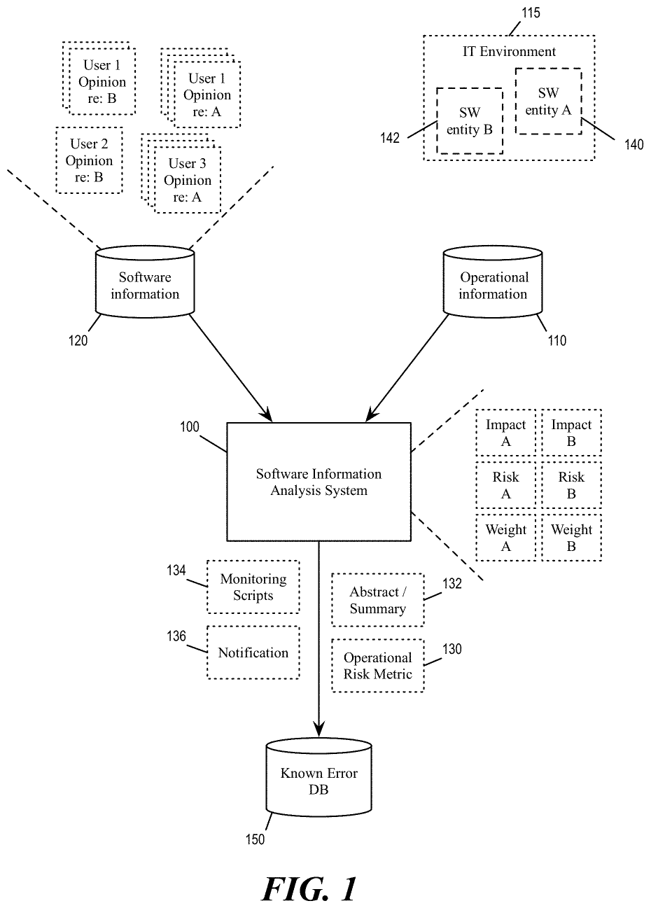

FIG. 1 illustrates a software information analysis system 100 that assess the operations risks of using a particular set of software in an Information Technology (IT) environment 115. The IT environment 100 may encompass hardware infrastructure and software services that are operational for a business or an individual. It may include commercially available components and/or privately developed proprietary components. Some of the components of the IT environment 115 may use or incorporate open-source software as source code or as a reference library. Some of these components of the IT environment 115 may rely on one or more remote services that run open-source software. As illustrated in the example of FIG. 1, the IT environment 115 uses a software entity A 140 and a software entity B 142.

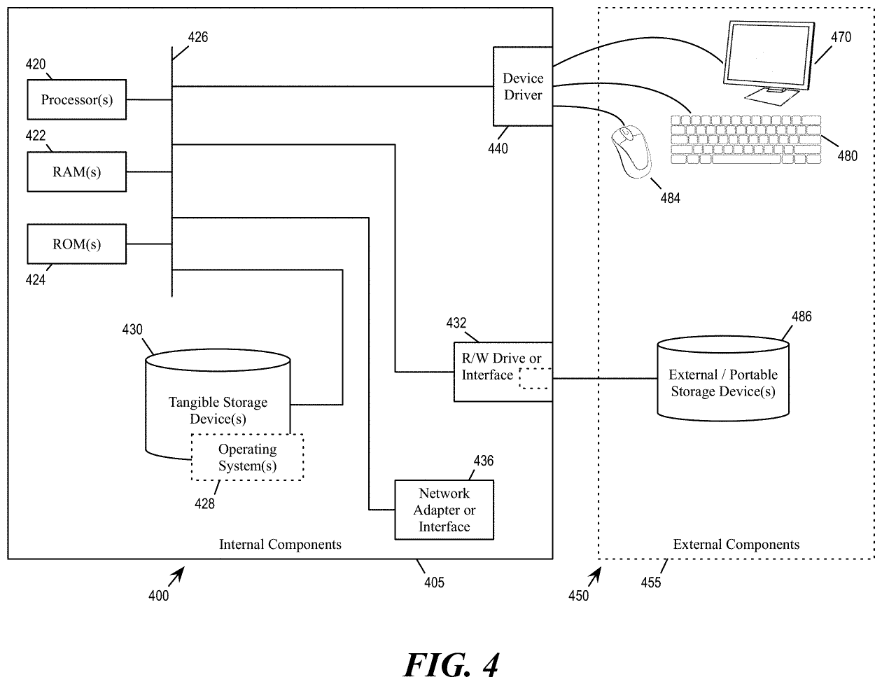

The software information analysis system 100 analyzes data regarding OSS and correlates the analyzed data with a series of operational data associated with the IT environment 115 and creates an operational impact metric. As illustrated, the software information analysis system 100 is a system that uses operational information 110 and software information 120 to produce a set of analysis results, including operational risk metric 130, abstract summary 132, additional monitoring 134, and notifications 136. In some embodiments, the software information analysis system 100 is implemented on an appropriately configured computing device. An example computing device 400 that may implement the software information analysis system 100 will be described by reference to FIG. 4 below. The software information analysis system may access a network (e.g., the Internet) and/or local storage devices to retrieve the operational information 110 and/or the software information 120.

The operational information 110 includes data and information regarding the information technology (IT) environment 115. The content of the operational information 110 may be stored in one or more storage devices that are accessible over a network to the software information analysis system 100. The operational information 110 may include source code, libraries, technical support notes, system configurations, operation manuals, system administrator logs, deployment blueprints and other types of information or documentation regarding the IT environment 115.

The software information 120 includes data and information regarding software entities (e.g., programs, source code fragments, libraries, services, etc.). The content of the software information 120 may be stored in one or more storage devices that are available for access over a network by the software information analysis system 100, or other members of the public. The software information may include release notes, wiki entries, open-source forums, OSS product information, fix-patches, readme files, version control logs, and other types of data relevant to various open-source products. As illustrated in the example of FIG. 1, the software information 120 includes opinions written by various users, contributors, or participants of OSS, including those related to software entities A and B (which may be open-source entities) that are used by one or more applications operating in the IT environment 115.

The software information analysis system 100 retrieves data from the operational information 110 and the software information 120 to perform software entity extraction, i.e., discovering or identifying software entities that are used in the IT environment 115. For example, the IT environment 115 may be using a set of OSS packages, and the operational information 110 and the software information 120 are used to identify software entities (e.g., 140 and 141) that are open-source entities (e.g., open-source programs, source code fragments, packages, libraries, services, etc.) that are used by the applications of the IT environment 115. In some embodiments, the system 100 may learn characteristics or footprints of software entities from the software information 120, then applies the learned characteristics to discover or extract matching software entities in the operational information 110. In some embodiments, the system 100 may perform entity extraction by using statistical methods such as Markov models or conditional random fields (CRF) to source code of applications, instrumentation data of the hardware infrastructure, or other types information. The software information analysis system 100 may also detect and characterize the semantic relations between the extracted entities using feature detection techniques based on background knowledge. The software information analysis system 100 may further perform abstractive summarization to produce abstract summary 132 from the discovered entities and relationships.

Based on the extracted software entities, the software information analysis system 100 extracts opinions from the software information 120 that are relevant to the software entities that are discovered in the IT environment 115. The system also performs opinion mining to discover sentiments of users or open-source participants regarding various software entities, particularly the software entities used by one or more applications operating in the IT environment 115. The software information analysis system 100 may classify each extracted opinion as positive, negative, or neutral. The system may also classify each extracted opinion as objective versus subjective. The opinions and their sentiments may be mined from tickets, root cause analysis (RCA), version control logs, known error database, etc.

When using the extracted opinion to generate analytical result such as operational risk metric 130, the software information analysis system 100 may apply weighting to each extracted opinion. In some embodiments, each opinion is weighted based on the identity of the open-source participant or contributor who authored the opinion. In some embodiments, each opinion is weighted based on a level of participation in the open-source forums by the opinion's author, for example, an author who writes frequently about a particular piece of open-source software or an author who has contributed directly to the programming of the open-source software, may be weighted more heavily than those who contribute or participate infrequently. In some embodiments, an opinion that is drastically different from most other opinions (i.e., an outlier opinion) is given a lower weight or zero weight.

In some embodiments, the software information analysis system 100 calculates the operational risk metric 130 as a value quantifying risk relative to impact of using the extracted software entities. In some embodiments, when calculating the operational risk metric for the IT environment 115, the system quantifies risks and their corresponding impact based on opinions collected from the software information 120 that are related to the software entities used by one or more applications operating in the IT environment 115.

In some embodiments, the system assesses the risk by identifying changes in opinions (compared to previous opinions), e.g., by determining whether (e.g., the sentiment of) an opinion expressed regarding an issue and/or an open-source entity has changed towards negative, positive, or has remained neutral. In some embodiments, the risk associated with an issue is categorized, e.g., performance, crash, deployability, etc. In some embodiments, the system outputs different sets of operational risk metrics for the different categories of risk. In some embodiments, risks of certain categories are weighted more heavily or assigned larger values than other types of risks when calculating the operational risk metrics of the IT environment 115.

In some embodiments, the system quantifies the impact of issues mentioned in the extracted opinions that are related to the extracted software entities, specifically issues that are highlighted in negative opinion statement (e.g., statements in opinions that are determined to have negative sentiment). The impact may be determined by referencing a configuration of the IT environment such as the environment's deployment blueprint. The impact may also be determined by referencing a configuration of the software entities that can be found in a configuration management database (CMDB).

In the example illustrated in FIG. 1, in order to determine the operational risk metric 130 for the IT environment 115, the software information analysis system 100 first discovers that the IT environment 115 is using a software entity A 140 and a software entity B 142. The software information analysis system 100 quantifies the impact and risks for the software entity A 140 and the software entity B 142. The quantified values of risks and impacts may be weighted based on information extracted from the software information 120, such as the sentiments of the opinions expressed regarding issues that relate to the software entities A and B, or the participation levels of the authors of the opinions, or the categories of the risks involved, or whether a particular opinion is an outlier opinion.

In some embodiments, the software information analysis system 100 generates operational risk metrics for different issues and by ranking the different issues according to their respective operating risk metrics. Some of the information generated by the software information analysis system 100, including various data and metrics, are stored in a known-error database 150. The known-error database 150 may be used for managing problems, tracking incidents, and providing feedbacks to improve the performance and security of the IT environment 115. The system 100 may update the known-error database based on the calculated operational risk metric and the identified software entities and relationships. For example, the known-error database 150 may be updated to identify the various issues, the components of the IT environment that are impacted by those issues, as well as the operational risks metrics associated with those issues.

The software information analysis system 100 may also establish additional monitors for potentially affected resources in the supported IT environment. For example, in some embodiments, the software information analysis system 100 may determine which additional applications or modules in the IT environment 115 interface or use the identified software entities, and correspondingly generate programs or scripts (e.g., monitoring scripts 134) to target those applications or modules for monitoring.

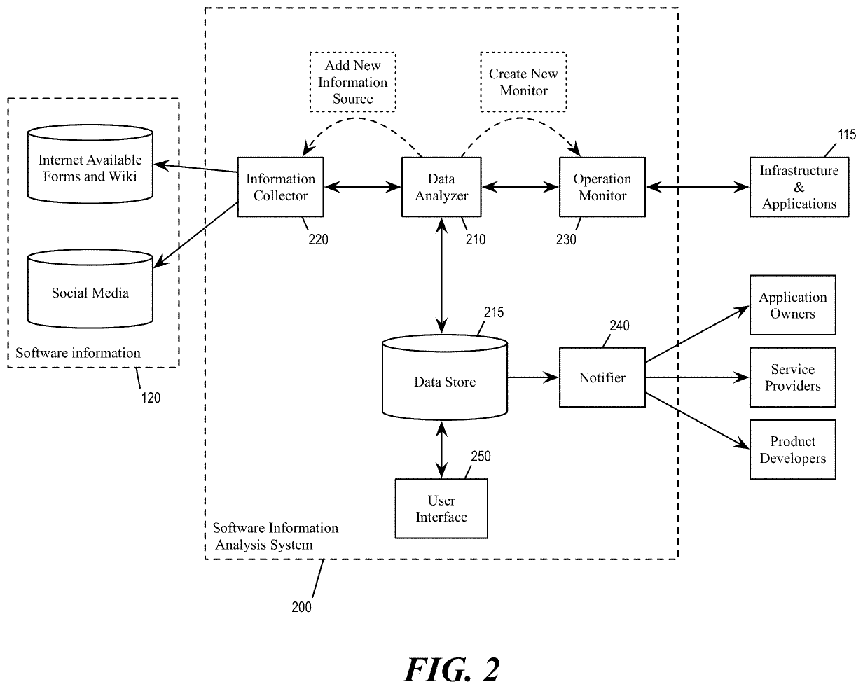

FIG. 2 illustrates a block diagram of an example implementation of the software information analysis system 100. As illustrated, a computing device 200 implements the software information analysis system 100. The computing device 200 implements a data analyzer 210, a information collector 220, an operation monitor 230, a notifier 240, and a user interface 250. In some embodiments, the modules 210-250 are modules of software instructions being executed by one or more processing units (e.g., a processor) of the computing device 200. In some embodiments, the modules 210-250 are modules of hardware circuits implemented by one or more integrated circuits (ICs) of an electronic apparatus. Though the modules 210, 220, 230, 240, and 250, are illustrated as being separate modules, some of the modules can be combined into a single module. For example, the functionalities of the data analyzer 210, the information collector 220, and the operation monitor 230 can be merged into the data collection and analysis module 210.

The data analyzer 210 receives data from the information collector 220 and the operation monitor 230. The information collector 220 collects data from various sources of the software information 120, including various Internet forums, wikis, social media, etc. From these sources the software information analysis system 200 may glean useful opinions regarding various open-source software, including those used by the IT environment 115. The operation monitor 230 collects data from various components of the IT environment, including its various hardware infrastructure and software applications. The data collected may include operational data of components of the IT environment (which may include operational data of software entities and non-software entities.) The operation monitor 230 or the information collector 220 may also collect manuals, logs, technical support requests, or other types information or documentation that pertain to the IT environment. The collected data are stored in a data store 215, which is a storage device of the computing device 200.

The data analyzer 210 retrieves the data retrieved by the information collector 220 and the operation monitor 230 from the data store 215 to perform operational risk analysis. Specifically, the data analyzer 210 identifies one or more software entities from the data provided by the information collector 220 and the operation monitor 230. The data analyzer also extracts opinions regarding the identified one or more software entities from the data provided by the information collector 220. The data analyzer 210 quantifies the impact and risks for the identified software entities. The quantified values of risks and impacts may be weighted based on information extracted by the information collector 220, such as the sentiments of the opinions expressed regarding issues that are related to the identified software entities, or the participation levels of the authors of the opinions, or the categories of the risk involved, or whether a particular opinion is an outlier opinion. During the operational risk analysis, various intermediate data are stored in the data store 215. The result of the analysis, including the operational risk metrics computed from the quantified and weighted risk and impacts, may also be stored in the data store 215.

In some embodiments, the data analyzer 210 may dynamically add additional sources for Software information collection. For example, when parsing through a particular forum for relevant opinions, the data analyzer 210 may come across other websites or servers from which relevant Software information can be gleaned. The data analyzer 210 may in turn inform the information collector 220 to add one or more new information sources. The data analyzer 210 may also come across a technical discussion that identifies certain functionalities or components of the IT environments 115 as being likely to have errors and therefore is useful to monitor. The data analyzer 210 may in turn inform the software operation monitor 230 to add corresponding new monitors.

The notifier 240 fetches data such as operational risk metrics from the data store 215 and communicates the data to application owners, service providers, product developers, and other interested parties. The content of the data store 215 may also be communicated to a known error database. The content of the data store 215 can also be directly accessed by the user interface 250.

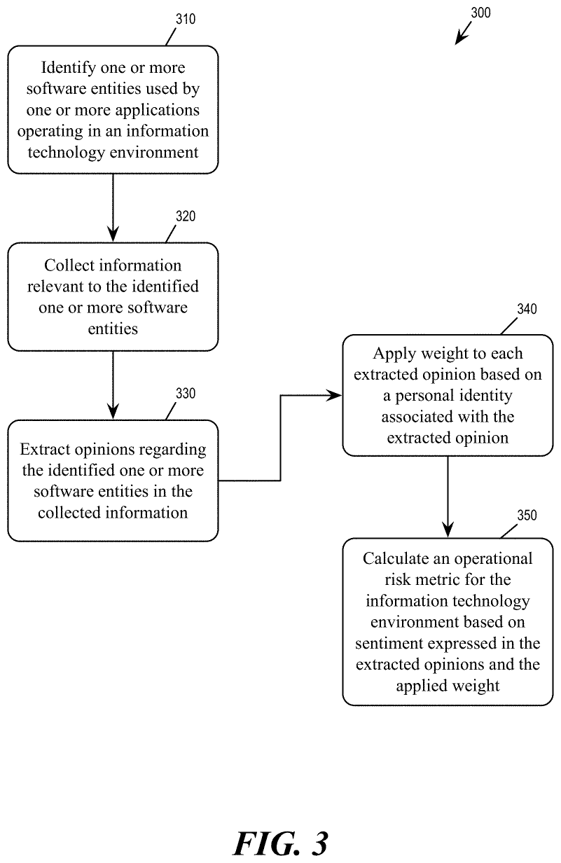

FIG. 3 conceptually illustrates a process 300 for assessing operational risks in using open-source software, consistent with an exemplary embodiment. In some embodiments, one or more processing units (e.g., processor) of a computing device implementing the software information analysis system 100 (e.g., the computing device 200) perform the process 300 by executing instructions stored in a computer readable medium.

The system identifies (at block 310) one or more software entities used by one or more applications operating in an information technology environment. In various embodiments, the software entities may be identified from source code of applications in the IT environment, from libraries that are used by the applications or services in the IT environment, from documentations regarding the IT environment, etc. In some embodiments, the system may learn characteristics or footprints of software entities from an information source (e.g., software information 120), then applies the learned characteristics to discover or extract matching software entities in the operational information.

The system collects (at block 320) information relevant to the identified one or more software entities. The information relevant to the one or more identified software entities may include release notes, product information, technical support requests, open-source forums, system administrator logs, system configurations, and deployment blueprints of the information technology environment. The information relevant to the identified software entities may be retrieved from the same information source from which the characteristics used to identify the software entities are learned. In some embodiments, the system examines a known-error database for entries regarding the software entities. If no entries exist in the known-error database for the identified software entities, the system creates an entry to be populated.

The system extracts (at block 330) opinions regarding the identified one or more software entities in the information collected at block 320. In some embodiments, when calculating the operational risk metric, the system identifies outlier opinions and excludes them (or assigns the outlier opinions less weight).

The system applies (at block 340) weights to each extracted opinion based on a personal identity (of e.g., an open-source participant) associated with the extracted opinion. The system calculates (at block 350) an operational risk metric for the information technology environment based on sentiments expressed in the extracted opinions and the applied weights. In other words, the system assists in identifying potential issues for using the software entities based on how opinions regarding the software entities are expressed and identifies who expressed those opinions.

In some embodiments, the operational risk metric is a value quantifying risk relative to an impact of using the extracted software entities, where the impact of an issue mentioned in the extracted opinions is quantified based on configuration data of the software entities and/or of the IT environment. In some embodiments, risks of different categories (e.g., performance, crash, deployability, etc.) are weighted differently or assigned different values. In some embodiments, the system detects change in sentiments regarding an issue mentioned in the extracted opinions when determining risk.

Though not illustrated, in addition to generating the operational risk metric, the system may identify one or more software entities in the applications for further monitoring based on the calculated operational risk metric. The system may also update the known-error database based on the calculated operational risk metric and the identified software entities and relationships. The system may also identify additional monitors or sources of Software information for further analysis in order to refine the calculation of the operational risk metric.

By analyzing the structure of an IT environment and by collecting information on open-source software that are used by the IT environment, the software information analysis system is able to provide a quick operational risk assessment for the IT environment for using the open-source software. The system assists in identifying potential issues for using the software entities by analyzing a potentially very large set of information by, for example, applying artificial intelligence techniques (e.g., sentiment analysis) on how opinions regarding the software entities are expressed and who expressed those opinions. Moreover, the system contributes to the accumulation of knowledge regarding the use of the open-source software in a known error database, thereby improving efficiency and accuracy of the hardware of the IT environment.

The present application may be a system, a method, and/or a computer program product at any possible technical detail level of integration. The computer program product may include a computer readable storage medium (or media) having computer readable program instructions thereon for causing a processor to carry out aspects of the present disclosure.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device. Computer readable program instructions for carrying out operations of the present disclosure may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present disclosure.

Aspects of the present disclosure are described herein with reference to flowchart illustrations and/or block diagrams of methods, apparatus (systems), and computer program products according to embodiments of the disclosure. It will be understood that each block of the flowchart illustrations and/or block diagrams, and combinations of blocks in the flowchart illustrations and/or block diagrams, can be implemented by computer readable program instructions. These computer readable program instructions may be provided to a processor of a computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks. The flowchart and block diagrams in the Figures (e.g., FIG. 3) illustrate the architecture, functionality, and operation of possible implementations of systems, methods, and computer program products according to various embodiments of the present disclosure. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

FIG. 4 shows a block diagram of the components of data processing systems 400 and 450 that may be used to implement a system for assessing operational risks for using open-source software in an IT environment (e.g., the software information analysis system 100) in accordance with an illustrative embodiment of the present disclosure. It should be appreciated that FIG. 4 provides only an illustration of one implementation and does not imply any limitations with regard to the environments in which different embodiments may be implemented. Many modifications to the depicted environments may be made based on design and implementation requirements.

Data processing systems 400 and 450 are representative of any electronic device capable of executing machine-readable program instructions. Data processing systems 400 and 450 may be representative of a smart phone, a computer system, PDA, or other electronic devices. Examples of computing systems, environments, and/or configurations that may represented by data processing systems 400 and 450 include, but are not limited to, personal computer systems, server computer systems, thin clients, thick clients, hand-held or laptop devices, multiprocessor systems, microprocessor-based systems, network PCs, minicomputer systems, and distributed cloud computing environments that include any of the above systems or devices.

The data processing systems 400 and 450 may include a set of internal components 405 and a set of external components 455 illustrated in FIG. 4. The set of internal components 405 includes one or more processors 420, one or more computer-readable RAMs 422 and one or more computer-readable ROMs 424 on one or more buses 426, and one or more operating systems 428 and one or more computer-readable tangible storage devices 430. The one or more operating systems 428 and programs such as the programs for executing the process 300 are stored on one or more computer-readable tangible storage devices 430 for execution by one or more processors 420 via one or more RAMs 422 (which typically include cache memory). In the embodiment illustrated in FIG. 4, each of the computer-readable tangible storage devices 430 is a magnetic disk storage device of an internal hard drive. Alternatively, each of the computer-readable tangible storage devices 430 is a semiconductor storage device such as ROM 424, EPROM, flash memory or any other computer-readable tangible storage device that can store a computer program and digital information.

The set of internal components 405 also includes a R/W drive or interface 432 to read from and write to one or more portable computer-readable tangible storage devices 486 such as a CD-ROM, DVD, memory stick, magnetic tape, magnetic disk, optical disk or semiconductor storage device. The instructions for executing the process 300 can be stored on one or more of the respective portable computer-readable tangible storage devices 486, read via the respective R/W drive or interface 432 and loaded into the respective hard drive 430.

The set of internal components 405 may also include network adapters (or switch port cards) or interfaces 436 such as a TCP/IP adapter cards, wireless Wi-Fi interface cards, or 3G or 4G wireless interface cards or other wired or wireless communication links. Instructions of processes or programs described above can be downloaded from an external computer (e.g., server) via a network (for example, the Internet, a local area network or other, wide area network) and respective network adapters or interfaces 436. From the network adapters (or switch port adaptors) or interfaces 436, the instructions and data of the described programs or processes are loaded into the respective hard drive 430. The network may comprise copper wires, optical fibers, wireless transmission, routers, firewalls, switches, gateway computers and/or edge servers.

The set of external components 455 can include a computer display monitor 470, a keyboard 480, and a computer mouse 484. The set of external components 455 can also include touch screens, virtual keyboards, touch pads, pointing devices, and other human interface devices. The set of internal components 405 also includes device drivers 440 to interface to computer display monitor 470, keyboard 480 and computer mouse 484. The device drivers 440, R/W drive or interface 432 and network adapter or interface 436 comprise hardware and software (stored in storage device 430 and/or ROM 424).

It is to be understood that although this disclosure includes a detailed description on cloud computing, implementation of the teachings recited herein are not limited to a cloud computing environment. Rather, embodiments of the present disclosure are capable of being implemented in conjunction with any other type of computing environment now known or later developed. Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

On-demand self-service: a cloud consumer can unilaterally provision computing capabilities, such as server time and network storage, as needed—automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations. Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud-computing environment is service oriented with a focus on statelessness, low coupling, modularity, and semantic interoperability. At the heart of cloud computing is an infrastructure that includes a network of interconnected nodes.

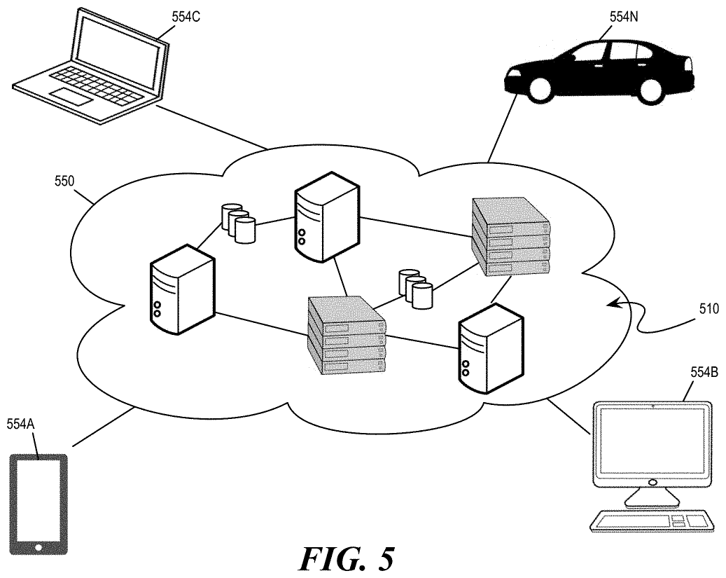

Referring now to FIG. 5, an illustrative cloud computing environment 550 is depicted. As shown, cloud computing environment 550 includes one or more cloud computing nodes 510 with which local computing devices used by cloud consumers, such as, for example, personal digital assistant (PDA) or cellular telephone 554A, desktop computer 554B, laptop computer 554C, and/or automobile computer system 554N may communicate. Nodes 510 may communicate with one another. They may be grouped (not shown) physically or virtually, in one or more networks, such as Private, Community, Public, or Hybrid clouds as described hereinabove, or a combination thereof. This allows cloud computing environment 550 to offer infrastructure, platforms and/or software as services for which a cloud consumer does not need to maintain resources on a local computing device. It is understood that the types of computing devices 554A-N shown in FIG. 5 are intended to be illustrative only and that computing nodes 510 and cloud computing environment 550 can communicate with any type of computerized device over any type of network and/or network addressable connection (e.g., using a web browser).

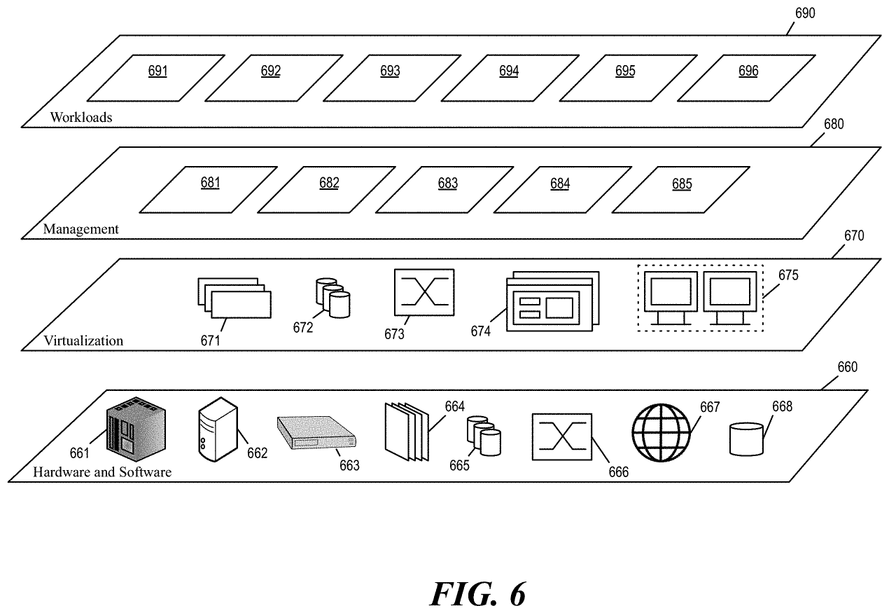

Referring now to FIG. 6, a set of functional abstraction layers provided by cloud computing environment 550 (of FIG. 5) is shown. It should be understood that the components, layers, and functions shown in FIG. 6 are intended to be illustrative only and embodiments of the disclosure are not limited thereto. As depicted, the following layers and corresponding functions are provided:

Hardware and software layer 660 includes hardware and software components. Examples of hardware components include: mainframes 661; RISC (Reduced Instruction Set Computer) architecture based servers 662; servers 663; blade servers 664; storage devices 665; and networks and networking components 666. In some embodiments, software components include network application server software 667 and database software 668.

Virtualization layer 670 provides an abstraction layer from which the following examples of virtual entities may be provided: virtual servers 671; virtual storage 672; virtual networks 673, including virtual private networks; virtual applications and operating systems 674; and virtual clients 675.

In one example, management layer 680 may provide the functions described below. Resource provisioning 681 provides dynamic procurement of computing resources and other resources that are utilized to perform tasks within the cloud computing environment. Metering and Pricing 682 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 683 provides access to the cloud-computing environment for consumers and system administrators. Service level management 684 provides cloud computing resource allocation and management such that required service levels are met. Service Level Agreement (SLA) planning and fulfillment 685 provide pre-arrangement for, and procurement of, cloud computing resources for which a future requirement is anticipated in accordance with an SLA.

Workloads layer 690 provides examples of functionality for which the cloud computing environment may be utilized. Examples of workloads and functions which may be provided from this layer include: mapping and navigation 691; software development and lifecycle management 692; virtual classroom education delivery 693; data analytics processing 694; transaction processing 695; and workload 696. In some embodiments, the workload 696 performs some of the operations of the software information analysis system 100.

The foregoing one or more embodiments implements Software information analysis system within a computer infrastructure by having one or more computing devices collecting and analyzing open-source software information and IT environment information, including extracting opinions regarding and calculating an operational risk metric for the IT environment based on sentiments expressed in the extracted opinions.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computing device comprising:
a processor; and
a storage device storing a set of instructions, wherein an execution of the set of instructions by the processor configures the computing device to perform acts comprising:
identifying one or more software entities used by one or more applications operating in an environment;
collecting information relevant to the identified one or more software entities;
extracting opinions regarding the identified one or more software entities in the collected information; and
calculating an operational risk metric for the environment based on one or more sentiments expressed in the extracted opinions, wherein each extracted opinion is weighted based on a personal identity associated with the extracted opinion.

2. The computing device of claim 1, wherein the operational risk metric is a value quantifying a risk relative to an impact of using the identified software entities.

3. The computing device of claim 1, wherein calculating the operational risk metric comprises quantifying an impact of an issue identified in the extracted opinions.

4. The computing device of claim 1, wherein calculating the operational risk metric comprises assigning a category to a risk associated with an issue identified in the extracted opinions, wherein risks of different categories are assigned different values.

5. The computing device of claim 1, wherein calculating the operational risk metric comprises assessing a risk by detecting a change in a sentiment regarding an issue identified in the extracted opinions

6. The computing device of claim 1, wherein calculating the operational risk metric comprises identifying and excluding outlier opinions.

7. A computer-implemented method comprising:
identifying one or more software entities used by one or more applications operating in an environment;
collecting information relevant to the identified one or more software entities;
extracting opinions regarding the identified one or more software entities in the collected information; and
calculating an operational risk metric for the environment based on one or more sentiments expressed in the extracted opinions, wherein each extracted opinion is weighted based on a personal identity associated with the extracted opinion.

8. The computer-implemented method of claim 7, wherein the operational risk metric is a value quantifying a risk relative to an impact of using the identified software entities.

9. The computer-implemented method of claim 7, wherein calculating the operational risk metric comprises quantifying an impact of an issue identified in the extracted opinions.

10. The computer-implemented method of claim 7, wherein calculating the operational risk metric comprises assigning a category to a risk associated with an issue identified in the extracted opinions, wherein risks of different categories are assigned different values.

11. The computer-implemented method of claim 7, wherein calculating the operational risk metric comprises assessing a risk by detecting a change in a sentiment regarding an issue mentioned in the extracted opinions

12. The computer-implemented method of claim 7, wherein calculating the operational risk metric comprises identifying and excluding outlier opinions.

13. The computer-implemented method of claim 7, further comprising identifying one or more software entities in the environment for further monitoring based on the calculated operational risk metric.

14. The computer-implemented method of claim 7, further comprising updating a known-error database based on the calculated operational risk metric and the identified software entities and relationships.

15. A computer program product comprising:
one or more non-transitory computer-readable storage devices and program instructions stored on at least one of the one or more non-transitory storage devices, the program instructions executable by a processor, the program instructions comprising sets of instructions for:
identifying one or more software entities used by one or more applications operating in an environment;
collecting information relevant to the identified one or more software entities;
extracting opinions regarding the identified one or more software entities in the collected information; and
calculating an operational risk metric for the environment based on one or more sentiments expressed in the extracted opinions, wherein each extracted opinion is weighted based on a personal identity associated with the extracted opinion.

16. The computer program product of claim 15, wherein the operational risk metric is a value quantifying a risk relative to an impact of using the identified software entities.

17. The computer program product of claim 15, wherein calculating the operational risk metric comprises quantifying an impact of an issue identified in the extracted opinions.

18. The computer program product of claim 15, wherein calculating the operational risk metric comprises assigning a category to a risk associated with an issue mentioned in the extracted opinions, wherein risks of different categories are assigned different values.

19. The computer program product of claim 15, wherein calculating the operational risk metric comprises assessing a risk by detecting a change in a sentiment regarding an issue mentioned in the extracted opinions

20. The computer program product of claim 15, wherein calculating the operational risk metric comprises identifying and excluding outlier opinions.
